(19) United States
(12) Patent Application Publication
(10) Pub. No.: US 2015/0346989 A1
(43) Pub. Date: Dec. 3, 2015

(54) USER INTERFACE FOR APPLICATION AND DEVICE

(71) Applicant: Samsung Electronics Co., Ltd., Gyeonggi-do (KR)

(72) Inventor: Ho Young LEE, Seoul (KR)

(21) Appl. No.: 14/724,110

(22) Filed: May 28, 2015

(30) Foreign Application Priority Data
May 28, 2014 (KR) 10-2014-0064268

(51) Int. Cl. G06F 3/0484

(52) U.S. Cl. CPC G06F 3/04847; G06F 3/04842

(57) ABSTRACT

Disclosed is an electronic device for executing an application, including a display module configured to display a plurality of icons respectively corresponding to a plurality of applications on a screen, a user input reception module configured to receive a user input for one of the plurality of displayed icons, and a processor configured to select at least one application relating to an application corresponding to the user input, wherein the display module displays the application corresponding to the user input and the related application in widget form on a screen.

### PRIORITY

This application claims priority under 35 U.S.C. §119(a) to a Korean Patent Application filed on May 28, 2014 in the Korean Intellectual Property Office and assigned Serial number 10-2014-0064268, the contents of which are incorporated herein by reference.

### BACKGROUND OF THE INVENTION

1. Field of the Invention

The present invention relates generally to an electronic device, and more particularly, to a user interface (UI) displayed on a screen of the electronic device when an application is executed on the electronic device.

2. Description of the Related Art

With the recent development of digital technology, mobile electronic devices capable of processing communication and personal information have been released, such as mobile communication terminals, personal digital assistants (PDAs), electronic organizers, smartphones, and tablet personal computers (PCs).

Conventional electronic devices tend to have functions such as voice and video call, message transmission/reception such as short message service (SMS)/multimedia message service (MMS) and e-mail, electronic organizer, image capturing, broadcast playback, video playback, music playback, Internet, messenger, and social networking service (SNS) functions.

Moreover, as user interfaces (UIs) or user experiences (UXs) for electronic devices develop, various effects are provided together during the execution and screen-switching of an electronic device. Accordingly, there is a need for a method and apparatus for conveniently displaying an object or a screen effect on a screen of an electronic device in response to a user input, particularly in an application driven by the electronic device.

### SUMMARY OF THE INVENTION

The present invention has been made to address at least the problems and/or disadvantages described above and to provide at least the advantages described below.

Accordingly, an aspect of the present invention is to provide an electronic device and method for displaying a predetermined object or a predetermined screen effect based on a user input received from a user.

In accordance with an aspect of the present invention, provided is an electronic device for executing an application, including a display module configured to display a plurality of icons respectively corresponding to a plurality of applications on a screen, a user input reception module configured to receive a user input for one of the plurality of displayed icons, and a processor configured to select at least one application corresponding to the user input, wherein the display module displays the application corresponding to the user input and the related application in widget form on a screen.

In accordance with another aspect of the present invention, provided is a method of displaying an application UI, including displaying a plurality of icons respectively corresponding to a plurality of applications on a screen, receiving a user input for one of the plurality of displayed icons, selecting at least one application corresponding to the user input, and displaying the application corresponding to the user input and the related application in widget form on a screen.

### BRIEF DESCRIPTION OF THE DRAWINGS

The above and other aspects, features, and advantages of certain embodiments of the present disclosure will become more apparent from the following description taken in conjunction with the accompanying drawings, in which:

FIG. 1 illustrates a network environment including an electronic device according to embodiments of the present invention;

FIG. 2A is a block diagram illustrating an electronic device according to embodiments of the present invention;

FIG. 2B illustrates a grouping operation of a processor according to embodiments of the present invention;

FIG. 3A illustrates an application UI displayed on a screen of an electronic device according to embodiments of the present invention;

FIG. 3B illustrates an application UI displayed on a screen of an electronic device according to embodiments of the present invention;

FIG. 3C illustrates an application UI displayed on a screen of an electronic device according to embodiments of the present invention;

FIG. 3D illustrates an application UI displayed on a screen of an electronic device according to embodiments of the present invention;

FIG. 4 illustrates an application UI displayed on a screen of an electronic device according to another embodiment of the present invention;

FIG. 5 illustrates an application UI displayed on a screen of an electronic device according to another embodiment of the present invention;

FIG. 6 illustrates an application UI displayed on a screen of an electronic device according to another embodiment of the present invention;

FIG. 7 illustrates an application UI displayed on a screen of an electronic device according to another embodiment of the present invention;

FIG. 8A illustrates an application UI for an operation that an electronic device displays an application in widget form according to embodiments of the present invention;

FIG. 8B illustrates an application UI for an operation that an electronic device displays an application in widget form according to embodiments of the present invention;

FIG. 8C illustrates an application UI for an operation that an electronic device displays an application in widget form according to embodiments of the present invention;

FIG. 9A illustrates an application UI for an operation that an electronic device displays an application in widget form according to another embodiment of the present invention;

FIG. 9B illustrates an application UI for an operation that an electronic device displays an application in widget form according to another embodiment of the present invention;

FIG. 10A illustrates an application UI for an operation that an electronic device displays an application in widget form according to another embodiment of the present invention;

FIG. 10B illustrates an application UI for an operation that an electronic device displays an application in widget form according to another embodiment of the present invention;

FIG. 10C illustrates an application UI for an operation that an electronic device displays an application in widget form according to another embodiment of the present invention;

FIG. 10D illustrates an application UI for an operation that an electronic device displays an application in widget form according to another embodiment of the present invention;

FIG. 10E illustrates an application UI for an operation that an electronic device displays an application in widget form according to another embodiment of the present invention;

FIG. 11A illustrates an application UI depending on a size change of an application screen according to embodiments of the present invention;

FIG. 11B illustrates an application UI depending on a size change of an application screen according to embodiments of the present invention;

FIG. 12 illustrates an application UI with an application screen including a plurality of areas according to embodiments of the present invention; and

FIG. 13 is a block diagram illustrating an electronic device according to embodiments of the present invention.

### DETAILED DESCRIPTION OF EMBODIMENTS OF THE INVENTION

Hereinafter, embodiments of the present invention are disclosed with reference to the accompanying drawings. Various modifications are possible in embodiments of the present invention and specific embodiments are illustrated in drawings and described in related detailed descriptions. However, the present invention is not limited thereto and it should be understood that the present invention covers all the modifications, equivalents, and/or replacements of this disclosure provided they come within the scope of the appended claims and their equivalents. With respect to the descriptions of the drawings, like reference numerals refer to like elements. In the following description, well-known functions or constructions are not described in detail since they would obscure the invention in unnecessary detail.

The terms “include,” “comprise,” and “have”, “may include,” “may comprise” and “may have” used herein indicate disclosed functions, operations, or existence of elements but do not exclude other functions, operations or elements. Additionally, in embodiments of the present invention, the terms “include,” “comprise,” “including,” and “comprising,” specify a property, region, fixed number, step, process, element and/or a component but do not exclude other properties, regions, fixed numbers, steps, processes, elements and/or components.

In embodiments of the present invention, the expression “A or B” or “at least one of A or/and B” may include all possible combinations of items listed together. For instance, the expression “A or B”, or “at least one of A or/and B” may indicate include A, B, or both A and B.

Terms such as “1st”, “2nd”, “first”, and “second used herein may refer to modifying various different elements of embodiments of the present invention, but do not limit the elements. For instance, such expressions do not limit the order and/or importance of corresponding components. The expressions may be used to distinguish one element from another element. For instance, both “a first electronic device” and “a second electronic device” are all electronic devices and indicate different electronic devices. For example, a first component may be referred to as a second component and vice versa without departing from the scope of the present invention.

In this disclosure, when one part, element, or device is referred to as being “connected” to another part, element, or device, it should be understood that the former can be “directly connected” to the latter, or “connected” to the latter via an intervening part, element, or device. In contrast, when an element is referred to as being “directly connected” or “directly coupled” to another element, there are no intervening elements present.

In embodiments of the present invention, terms used in this specification are used to describe specific embodiments of the present invention, and are not intended to limit the scope of the present invention. The terms in a singular form include plural forms unless they have a clearly different meaning in the context.

Unless otherwise indicated, all the terms used herein, which include technical or scientific terms, may have the same meaning that is generally understood by a person skilled in the art. In general, the terms defined in the dictionary should be considered to have the same meaning as the contextual meaning of the related art, and unless clearly defined herein, should not be understood abnormally or as having an excessively formal meaning.

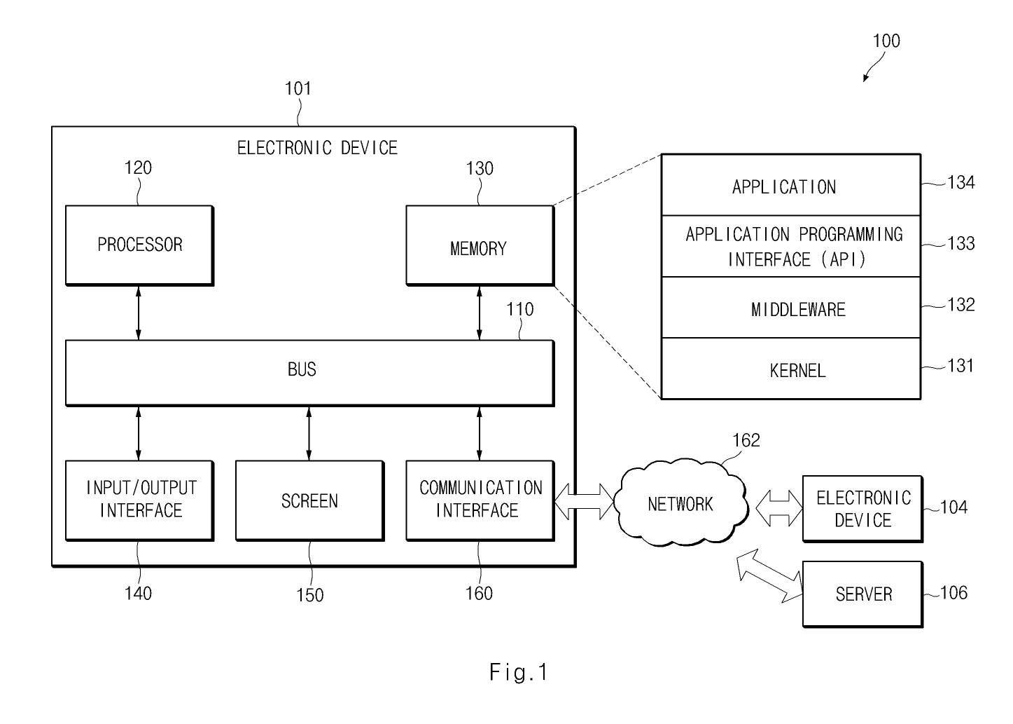

Additionally, an electronic device according to embodiments of the present invention may display an application UI described later with reference to FIGS. 1 to 13. For instance, electronic devices include at least one of smartphones, tablet personal computers (PCs), mobile phones, video phones, electronic book (e-book) readers, desktop personal computers (PCs), laptop personal computers (PCs), netbook computers, personal digital assistants (PDAs), portable multimedia player (PMPs), MP3 players, mobile medical devices, cameras, and wearable devices such as head-mounted-devices (HMDs) including electronic glasses, electronic apparel, electronic bracelets, electronic necklaces, electronic appcessories, electronic tattoos, and smart watches).

According to some embodiments of the present invention, an electronic device may be smart home appliances for displaying an application UI described later with reference to FIGS. 1 to 13. The smart home appliances include at least one of, for example, televisions, digital video disk (DVD) players, audios, refrigerators, air conditioners, cleaners, ovens, microwave ovens, washing machines, air cleaners, set-top boxes, TV boxes (for example, Samsung HomeSync™, Apple TV™ or Google TV™), game consoles, electronic dictionaries, electronic keys, camcorders, and electronic picture frames.

According to some embodiments of the present invention, an electronic device includes at least one of various medical devices such as magnetic resonance angiography (MRA), magnetic resonance imaging (MRI), computed tomography (CT), medical imaging, and ultrasonic devices, as well as navigation devices, global positioning system (GPS) receivers, event data recorders (EDRs), flight data recorders (FDRs), vehicle infotainment devices, marine electronic equipment such as marine navigation systems and gyro compasses, avionics, security equipment, vehicle head modules, industrial or household robots, financial institutions' automatic teller machines (ATMs), and stores' point of sales (POS), all of which display an application UI described later with reference to FIGS. 1 to 13.

In embodiments of the present invention, an electronic device includes at least one of part of furniture or buildings/structures supporting call forwarding service, electronic boards, electronic signature receiving devices, projectors, and various measuring instruments (for example, water, electricity, gas, or radio signal measuring instruments), all of which display an application UI described later with reference to FIGS. 1 to 13. An electronic device according to embodiments of the present invention may be one of the above-mentioned various devices or a combination thereof, and may be a flexible device. Furthermore, it is apparent to those skilled in the art that an electronic device according to embodiments of the present invention is not limited to the above-mentioned devices.

The term “user” in embodiments may refer to a person using an electronic device or a device using an electronic device, such as an artificial intelligent electronic device.

FIG. 1 illustrates a network environment 100 including an electronic device 101 according to embodiments of the present invention. Referring to FIG. 1, the electronic device 101 includes a bus 110, a processor 120, a memory 130, an input/output interface 140, a screen 150, and a communication interface 160.

The bus 110 is a circuit connecting the above-mentioned components to each other and delivering a communication such as a control message between the above-mentioned components.

The processor 120, for example, receives instructions from the above-mentioned other components through the bus 110, interprets the received instructions, and executes calculation or data processing according to the interpreted instructions.

For example, the processor 120 groups a plurality of applications installed on the electronic device 101, such as by each application page displayed on the screen 150 of the electronic device 101. The application page includes each icon corresponding to at least one application and changes into another application page based on a user input (for example, swiping the application page to the left/right).

At least two applications grouped into one group among a plurality of applications may interoperate. Interoperated applications included in the group may be displayed together with an application screen in widget form for each application based on a user input for selecting one application included in the group. Further to the interoperation, the plurality of applications set in groups may be executed simultaneously or sequentially based on one user input. For this, the interoperated applications may be managed in the memory 240 by being matched to each other.

The memory 130 stores instructions or data received from the processor 120 or other components or generated by the processor 120 or the other components. The memory 130 includes programming modules such as a kernel 131, a middleware 132, an application programming interface (API) 133, and applications 134. Each of the above-mentioned programming modules may be configured with software, firmware, hardware, or a combination of at least two thereof.

The kernel 131 controls or manages system resources such as the bus 110, processor 120, and memory 130, used for performing operations or functions implemented in the remaining other programming modules 134. The kernel 131 provides an interface for performing a controlling or managing operation by accessing an individual component of the electronic device 101 from the middleware 132, the API 133, or the applications 134.

The middleware 132 serves as an intermediary role for exchanging data as the API 133 or the applications 134 communicates with the kernel 131. In relation to job requests received from the applications 134, the middleware 132 performs a control such as scheduling or load balancing for the job requests by using a method of assigning a priority for using a system resource of the electronic device 101 to at least one application among the applications 134.

The API 133, as an interface for allowing the applications 134 to control a function provided from the kernel 131 or the middleware 132, includes at least one interface or function (for example, an instruction) for file control, window control, image processing, or character control.

According to embodiments of the present invention, the applications 134 include the various types of applications previously described herein. Additionally or alternatively, the applications 134 may relate to information exchange between the electronic device 101 and an external electronic device 104, such as a notification relay application for relaying specific information to the external electronic device or a device management application for managing the external electronic device.

For example, the notification relay application may have a function for relaying, to an external electronic device 104, notification information occurring from another application such as SMS/MMS, e-mail, health care, or an environmental information providing application of the electronic device 101. Additionally or alternatively, the notification relay application receives notification information from an external electronic device 104 and provides the received notification information to a user. The device management application, for example, manages functions or components of the external electronic device or the brightness of the external electronic device 104 communicating with the electronic device 101, an application operating in the external electronic device, or a call or message service provided from the external electronic device.

According to embodiments of the present invention, the applications 134 include a specified application according to the property or type of the external electronic device 104. For example, when an external electronic device is an MP3 player, the applications 134 include an application relating to music playback. Similarly, when an external electronic device is a mobile medical device, the applications 134 include an application relating to heath care. According to an embodiment of the present invention, the applications 134 include at least one of an application assigned to the electronic device 101 and an application received from an external electronic device such as the server 106 or the electronic device 104.

The input/output interface 140 delivers an instruction or data inputted from a user through an input/output device to the processor 120, the memory 130, the communication interface 160, or the data processing module 160 through the bus 110. For example, the input/output interface 140 provides to the processor 120 data on a user's touch inputted through a touch screen. The input/output interface 140 outputs, through the input/output device, instructions or data received from the processor 120, the memory 130, or the communication interface 160 through the bus 110. For example, the input/output interface 140 outputs voice data processed through the processor 120 to a user through a speaker.

The screen 150 displays such as multimedia and text data to a user.

The communication interface 160 connects a communication between the electronic device 101 and an external device such as the electronic device 104 or the server 106. For example, the communication interface 160 communicates with the external device in connection to the network 162 through wireless communication or wired communication. The wireless communication, for example, includes at least one of wireless fidelity (WiFi), Bluetooth® (BT), near field communication (NFC), global positioning system (GPS), and cellular communication such as third generation (3G), long term evolution (LTE), LTE-Advanced (LTE-A), code division multiple access (CDMA), wideband CDMA (WCDMA), universal mobile telecommunications system (UMTS), WiBro, or GSM, and at least one of a universal serial bus (USB), high definition multimedia interface (HDMI), recommended standard 232 (RS-232), and plain old telephone service (POTS).

According to an embodiment of the present invention, the network 162 is a telecommunications network including at least one of computer network, Internet, Internet of things, and telephone network. According to an embodiment of the present invention, a protocol such as transport layer, data link layer, or physical layer protocol for communication between the electronic device 101 and an external device is supported by at least one of the applications 134, the application programming interface 133, the middleware 132, the kernel 131, and the communication interface 160.

According to an embodiment of the present invention, the server 106 supports the driving of the electronic device 101 by performing at least one of operations (or functions implemented by the electronic device 101. For example, the server 106 includes a grouping module capable of supporting the processor 120, which is implemented in the electronic device 101. The grouping module, as including at least one component of the processor 120, performs on behalf of the processor 120 at least one operation among operations that the processor 120 performs.

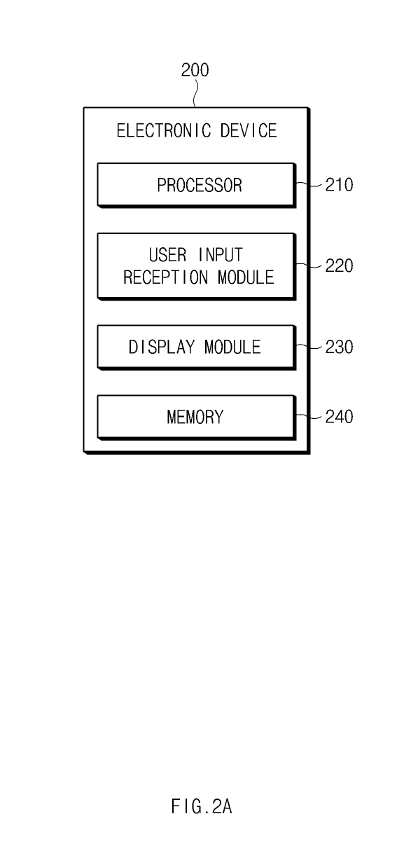

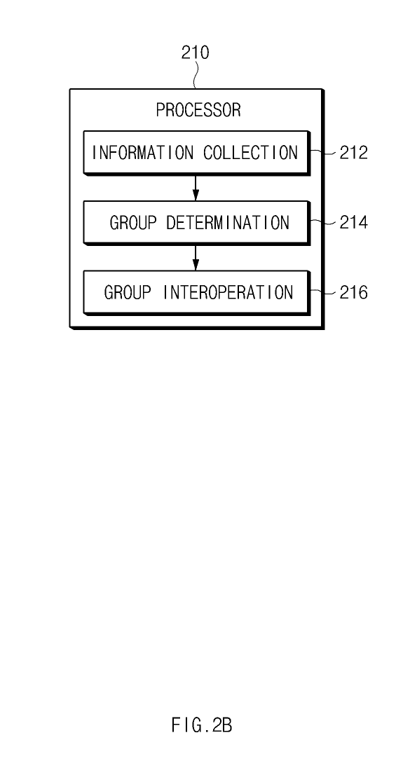

FIG. 2A is a block diagram illustrating an electronic device 200 according to embodiments of the present invention. Referring to FIG. 2A, the electronic device 200 includes a processor 210, a user input reception module 220, a display module 230, and a memory 240. However, various modifications to components shown in FIG. 2A may be implemented.

For example, the electronic device 200 may further include a user interface for receiving a certain instruction or information from a user. The user interface may be an input device such as a keyboard, a mouse, and a Graphical User Interface (GUI) displayed on an image display device.

The processor 210 sets a plurality of applications in groups. The plurality of applications may refer to all application installed on the electronic device 200, or applications corresponding to an application icon included in one application page displayed on the screen 150 of the electronic device 200. For example, the processor 210 groups a plurality of applications corresponding to an application icon included in each application page.

The processor 210 collects information on each of a plurality of applications in order to set the plurality of applications in groups. For example, the processor 210 collects information necessary for grouping by using an installation file or log record of each of a plurality of applications.

The processor 210 enables a plurality of applications set in groups to interoperate with each other. Accordingly, the plurality of application set in groups may be executed simultaneously or sequentially based on one user input.

The user input reception module 220 receives a user input for one of a plurality of icons displayed on the screen 150 of the electronic device 200, such as an application grouped by the grouping module 210.

The processor 210 determines to allow at least two applications to be displayed in widget form on the screen 150 in response to the user input.

The user input includes a touch input on the screen 150 of the electronic device 200 by using a finger or a stylus including an S-pen. The touch input indicates a state in which a finger or a stylus physically contacts the screen 150 of the electronic device 200.

However, according to characteristics that the screen or the electronic device 200 supports, a user input according to embodiments of the present invention may be implemented even when a finger or a stylus does not contact a screen, often referred to as a “hover” or “hovering” input. For example, when a finger is within a predetermined distance to a screen, the electronic device detects an amount of change in the electromagnetic field by the finger, with which the user input reception module 220 determines whether a user input is made. In a similar manner, the user input reception module 220 determines that a touch input occurs when a stylus is within a predetermined distance to a screen.

When executing the at least two applications, the processor 210 displays each application screen in widget form.

According to embodiments of the present invention, the processor 210 displays a corresponding application screen in widget form based on a user input for an application that is already executing. For example, when a user is listening to music as a music listening application is already executed, the processor 210 displays a music listening application screen in widget form based on a user input for the music listening application. In this case, the music listening application screen provides information on the music in playback and/or a control icon for the music in playback.

According to embodiments of the present invention, the processor 210 displays a corresponding application screen in widget form based on a user input for an application and executes a corresponding application through a user input for the widget. For example, as a previous step for listening to music, a user enables a music listening application screen to be displayed in widget form on the screen 150 through a user input in order to obtain information on music to be played. In this case, the processor 210 executes the music listening application based on an additional user input of a user who wants to play the music. However, according to embodiments of the present invention, an operation for displaying a music listening application screen in widget form in order to obtain information on music to be played may be seen as “execution of music listening application”.

Based on a user input for one of grouped at least two applications, the processor 210 may simultaneously or sequentially display application screens corresponding to the grouped at least two applications.

The processor 210 determines to display at least two application screens displayed in widget form to be adjacent to each other on a screen.

The processor 210 determines the sizes of at least two application screens displayed in widget form.

According to embodiments of the present invention, the processor 210 determines the sizes of at least two application screens displayed in widget form to be smaller than the size of the screen of the electronic device 200 in widget form through various manners.

For example, the processor 210 determines the size of the application screen displayed in widget form based on a position at which the user input received from the user input reception module 220 is released.

The processor 210 determines the size of the application screen displayed in widget form based on the execution frequency of the application. The execution frequency of the application may be inquired by using the log records of a corresponding application.

Alternatively, the processor 210 determines the size of the application screen displayed in widget form based on a user setting for a corresponding application. For example, a user may manipulate a user input to preset the size of a corresponding application screen to be displayed in widget form.

However, according to embodiments of the present invention, the processor 210 determines the size of each of at least two application screens displayed in widget form to correspond to a size corresponding to the screen 150.

The processor 210 determines information included in the application screen displayed in widget form based on the size of the application screen. For example, in comparison to a small sized application screen, a large sized application screen includes more information. Alternatively, a large sized application screen includes the same information as a small sized application screen but may have larger-sized text or images.

When the application screen displayed in widget form is displayed on the screen 150, the processor 210 realigns icons corresponding to other applications, such as applications not displayed in widget form. For example, the processor 210 realigns icons corresponding to the not displayed applications in order to prevent icons corresponding to other applications from being covered by an application screen displayed in widget form. In this case, the processor 210 realigns the icons corresponding to the other applications by each category.

The display module 230 displays, on the screen, at least two applications that are determined by the processor 210 to be displayed in widget form.

Each of at least two application screens displayed in widget form may be displayed in one area of the screen 150. For example, an application screen may occupy one area of the screen 150 and an icon corresponding to another application may be disposed in an area where the application screen is not displayed.

Additionally, an icon already disposed at a position at which the application screen is displayed and corresponding to another application may be moved to a position where the application screen is not displayed, in order to prevent the icon from being covered by the application screen. Such moved icons may incur a change in their order by each category and are thus realigned.

The memory 240 stores data such as data inputted and outputted between each of components in and outside of the electronic device 200. For example, the memory 240 stores information on a group determined by the processor 210 or information on the size of an application screen. Examples of the memory 240 include a hard disk drive, Read Only Memory (ROM), Random Access Memory (RAM), flash memory, and a memory card, which exist inside or outside the electronic device 200.

It will be apparent to those skilled in the art that the processor 210, the user input reception module 220, the display module 230, and the memory 240 may be implemented separately or at least one of these components may be implemented integrally.

FIG. 2B illustrates a grouping operation of the processor 210 according to embodiments of the present invention. Referring to FIG. 2B, the processor 210 performs an information collection step 212, a group determination step 214, and a group interoperation step 216.

In step 212, the processor 210 collects information on a plurality of applications, such as a corresponding application from a file corresponding to each application (for example, an application installation file such as an android package (apk) file or an iphone/ipod/ipad application (ipa) file).

Application information includes category information of a corresponding application. The category corresponds to SNS, multimedia, game, scheduler, instant message, shopping, and web applications, for example.

The category information may be collected from the file corresponding to an application or may be directly collected from a user through a user input for receiving the application category.

According to embodiments of the present invention, the collected category information may be used for determining a group or may be used for realigning the icons of applications not executed.

The processor 210 collects the log information (record) of each of a plurality of applications. The log information includes an execution time of a corresponding application. Accordingly, the processor 210 checks the execution frequency of a corresponding application from log information during a predetermined period.

The processor 210 determines whether there is a new message for each of a plurality of applications or the number of new messages. The number of new messages may be displayed as a number on the icon of a corresponding application.

When there is a user setting for setting at least two applications among a plurality of applications as a group, the processor 210 collects user setting information on the at least two applications, including a user setting for setting the category of the at least two applications.

In step 214, the processor 210 determines at least two applications as one group by using the information collected in step 212.

For example, the processor 210 creates at least one group from a plurality of applications installed on the electronic device 200 by using the information collected in step 212.

In this case, a plurality of applications that are the targets of a group may be all applications installed on the electronic device 200. However, according to embodiments of the present invention, a plurality of applications that are the targets of a group may be applications included in each application page that is sequentially displayed on a screen through a user input.

The processor 210 determines, as a group, a plurality of applications corresponding to each category as previously described, by using the log information collected in step 212.

For example, the processor 210 determines a plurality of applications as a group based on a log-based continuity. For example, when a relatively high frequency that a user uses an “x” application for taking a picture, a “y” application for correcting the taken picture, and a “z” application for sequentially uploading the corrected picture is detected, the processor 210 determines the “x”, “y”, and “z” applications as a group.

The processor 210 determines, as a group, a plurality of applications that are not continuous but have a high execution frequency. When a user frequently uses an “xx” application for taking a picture, an “xy” application for purchasing an item, and an “xz” application for checking weather, the processor 210 determines the “xx”, “xy”, and “xz” applications as a group.

The processor 210 determines a plurality of applications as a group by using a time at which an application is executed as an additional variable. A user may use the “xz” application for checking weather at home before going to the place of business, use an “xa” application for checking a bus location when leaving home, and may use an “xb” application for watching news after boarding a bus. The processor 210 determines the “xz”, “xa”, and “xb” applications as a group with respect to a point corresponding to the time the user attends his/her place of business.

The processor 210 may determine a plurality of applications as a group by using log information through additional various methods, and thus the scope of the present invention is not limited to the above-mentioned embodiments of the present invention.

The processor 210 determines a plurality of applications having an unchecked new message as a group.

The processor 210 determines, as a group, a plurality of applications that receive a user input for setting a group from a user through a user setting.

In step 216, in order to execute the at least two applications together, the processor 210 mutually links the at least two applications.

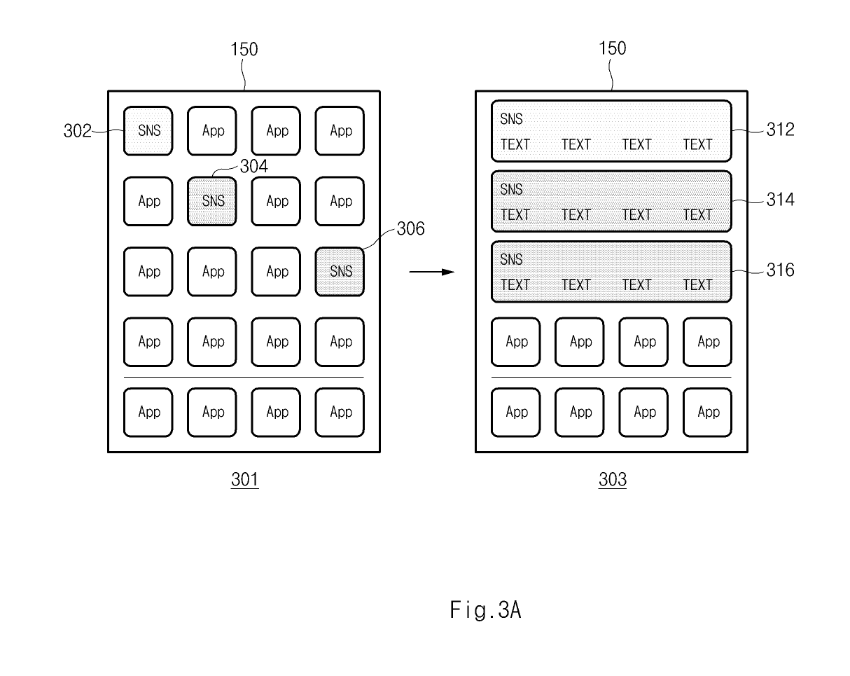

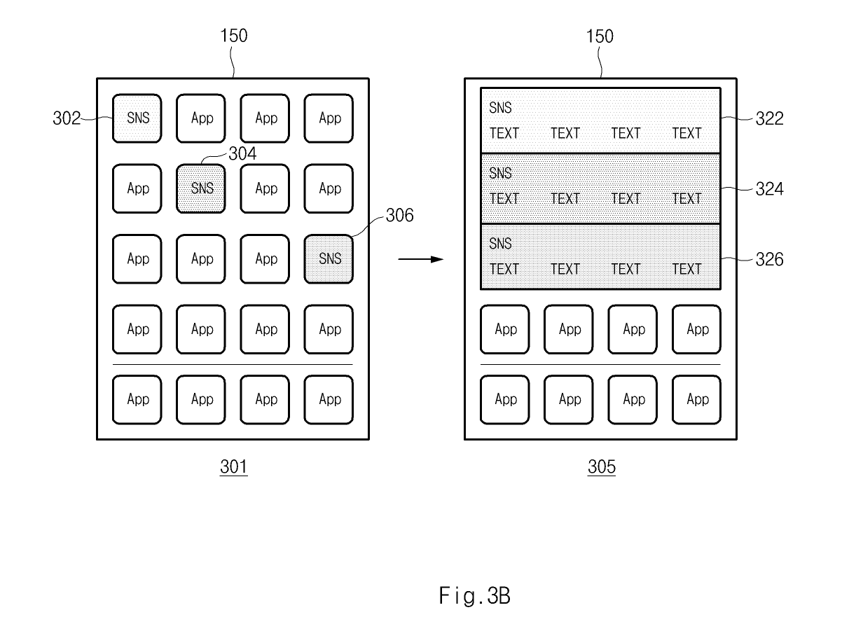

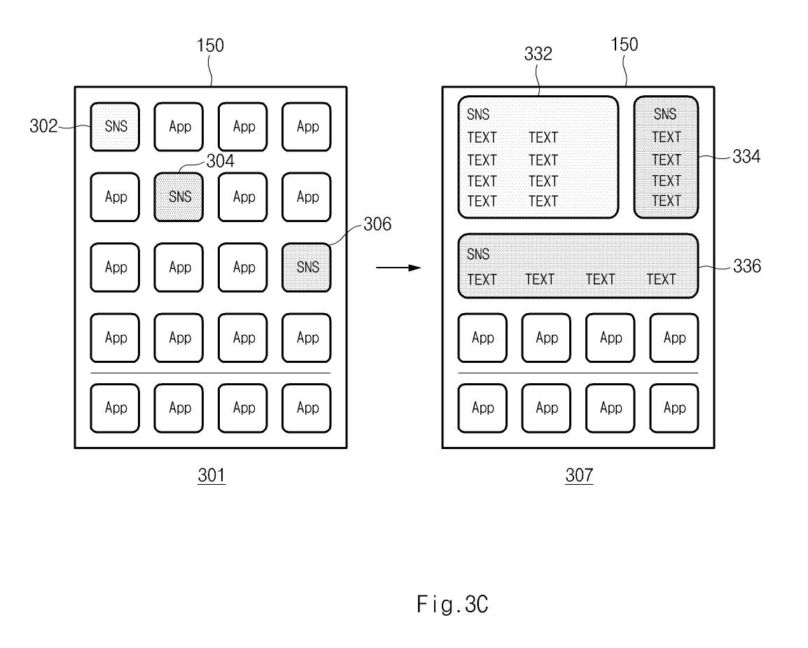

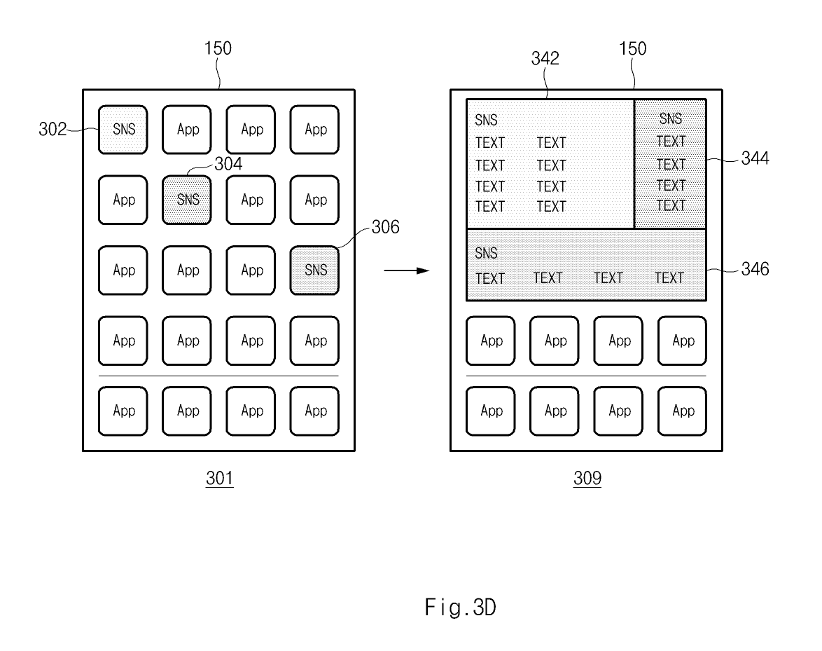

FIGS. 3A to 3D illustrate an application UI displayed on a screen of an electronic device according to embodiments of the present invention.

Referring to step 301 shown on the left-hand side of each of FIGS. 3A to 3D, the electronic device displays, on a screen 150, icons corresponding to a plurality of applications, which include icons 302, 304, and 306. Hereinafter, an icon corresponding to an arbitrary application will be referred to as an application icon.

The electronic device receives a user input for one of the SNS application icons 302, 304, and 306 displayed on the screen 150.

The step shown on the right-hand side of each of FIGS. 3A to 3D illustrates embodiments in which an application screen is displayed on the screen 150 of the electronic device based on the user input.

For example, step 301 in FIGS. 3A-3D is before the user input is received and steps 303, 305, 307 and 309 are after the user input is received.

Information shown on an application screen displayed in widget form, shown in FIGS. 3A to 3D, as information on a corresponding application, varies depending on each application. For example, information displayed on an application screen includes information on the last execution screen before a corresponding application is executed or information determined by a user setting.

Referring to step 301 of FIG. 3A, the electronic device displays, on the screen 150, SNS application screens 312, 314, and 316 respectively corresponding to the SNS application icons 302, 304, and 306 based on the user input. The SNS application screens 312, 314, and 316 may be displayed simultaneously or sequentially.

Application screen 312 corresponds to the SNS application icon 302, application screen 314 corresponds to the SNS application icon 304, and application screen 316 corresponds to the SNS application icon 306.

The SNS application screens 312, 314, and 316 may be adjacent to each other as shown in step 303 of FIG. 3A. According to embodiments of the present invention, the order of the SNS application screens 312, 314, and 316 are determined according to an initial arrangement order of the SNS application icons 302, 304, and 306. Additionally, as the order of the SNS application screens 312, 314, and 316 may be determined according to the execution frequency, user setting, or log-based continuity of a corresponding SNS application.

Referring to step 305 of FIG. 3B, the electronic device displays, on the screen 150, SNS application screens 322, 324, and 326 based on the user input.

Unlike the SNS application screens 312, 314, and 316 shown in step 303 of FIG. 3A, the SNS application screens 322, 324, and 326 shown in step 305 of FIG. 3B are displayed in a magazine UI/user experience (UX) form having an interval between each application screen.

Referring to step 307 of FIG. 3C, the electronic device displays, on the screen 150, SNS application screens 332, 334, and 336 based on the user input.

Unlike the SNS application screens 312, 314, and 316 shown in step 303 of FIG. 3A, each of the SNS application screens 332, 334, and 336 shown in step 307 of FIG. 3C are displayed in a different size.

According to embodiments of the present invention, an application screen size may be determined based on the execution frequency or user setting of a corresponding application.

Referring to step 309 of FIG. 3D, the electronic device displays, on the screen 150, SNS application screens 342, 344, and 346 based on the user input.

Unlike the SNS application screens 332, 334, and 336 shown in step 307 of FIG. 3C, the SNS application screens 342, 344, and 346 shown in step 309 of FIG. 3B are displayed in a magazine UI/user experience (UX) form with an interval between each application screen.

As described above, the size and order of an application screen shown in steps 303, 305, 307 and 309 of FIGS. 3A to 3D are determined based on the initial arrangement order, execution frequency, user setting, and log-based continuity of a corresponding application and are then displayed. The size and order of a displayed application screen may be readjusted by a user input.

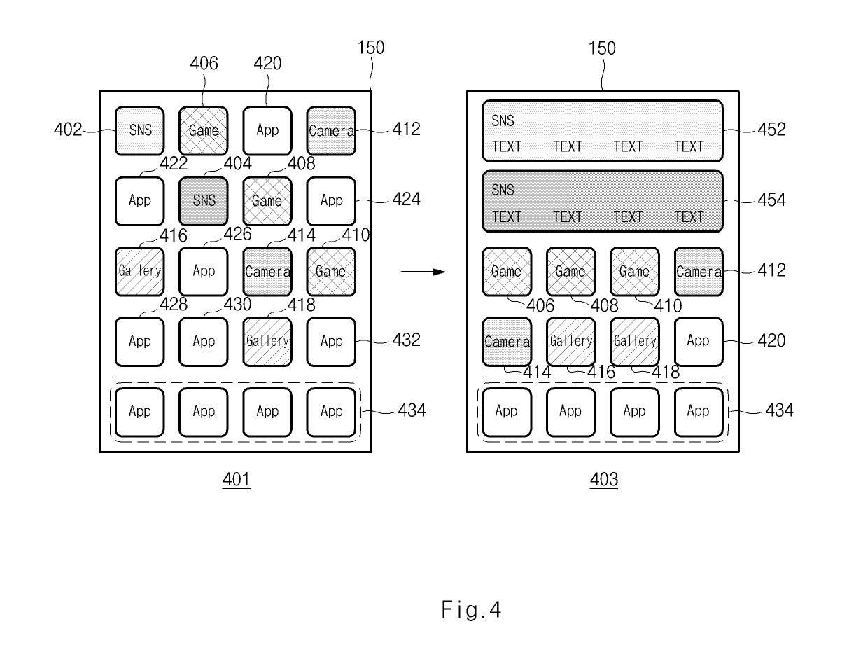

FIG. 4 illustrates an application UI displayed on a screen of an electronic device according to another embodiment of the present invention.

Referring to step 401, the electronic device displays, on a screen 150, SNS application icons 402 and 404, game application icons 406, 408 and 410, camera application icons 412 and 414, gallery application icons 416 and 418, application icons 420 to 432 of another category, and a favorite application icon area 434.

The SNS application icons 402 and 404 are included in a first group, the Game application icons 406, 408 and 410 are included in a second group, the Camera application icons 412 and 414 are included in a third group, and the Gallery application icons 416 and 418 are included in a fourth group, as illustrated.

Application icons 420 to 432 of another category correspond to ungrouped applications. It is noted that the “category” and the “group” may partly or exactly correspond to each other.

Step 403 represents an application UI displayed on the screen 150 of the electronic device when the SNS application icon 402 or 404 is activated.

In step 403, due to the activation of the SNS application icon 402 or 404, a plurality of corresponding SNS application screens 452 and 454 are displayed in widget form on the screen 150. The positions where the SNS application screens 452 and 454 are displayed may be determined in correspondence to the positions of the SNS application screens 402 and 404.

As the SNS application screens 452 and 454 are displayed, the electronic device realigns the position of each of application icons 406 to 432 in order to prevent application icons 406 to 432 corresponding to non-displayed applications from being covered by the SNS application screens 452 and 454.

For example, the electronic device realigns application icons 406 to 432 corresponding to non-displayed applications by each category or group. Accordingly, application icons 406 to 432 do not overlap the SNS application screens 422 and 424 and are aligned in the order of game application icons 406 to 410, camera application icons 412 and 414, gallery application icons 416 and 418, and application icons 420 to 432 and are then displayed on the screen 150.

Application icons corresponding to non-displayed applications may be realigned based on the number of application icons corresponding to the same category or group. For example, since there are three application icons for a game category or group, these icons may be disposed ahead of application icons for the camera or gallery category or group.

Returning to step 401, application icon 420 is ahead of game application icons 406 to 410, camera application icons 412 and 414, and gallery application icons 416 and 418. However, since application icon 420 does not have another application icon for a corresponding category or group, the electronic device disposes the camera application icons 412 and 414 and gallery application icons 416 and 418 ahead of application icon 420 as shown in step 403.

Application icons 422 to 432, which are behind the order of application icon 420 and do not have another application icon included in a corresponding category or group, are not displayed in step 403 because there is no space to be arranged on the screen 150 of step 403.

However, application icons 422 to 432 not displayed in step 403 may be displayed after application 420 by a user input that vertically scrolls the screen 150. In this case, application screens 452 and 454 disposed at the top in step 403 are hidden. Alternatively, the vertical scroll user input may hide application icons disposed at the top of an area excluding application screens 452 and 454.

The user input that scrolls the screen 150 vertically does not affect the favorite application icon area 434. Neither does a category or group specific realignment operation affect the favorite application icon area 434.

According to embodiments of the present invention, the user input that scrolls the screen 150 horizontally may enable the non-displayed application icons 422 to 432 to be displayed on the screen 150 similarly to the user input that scrolls the screen 150 vertically.

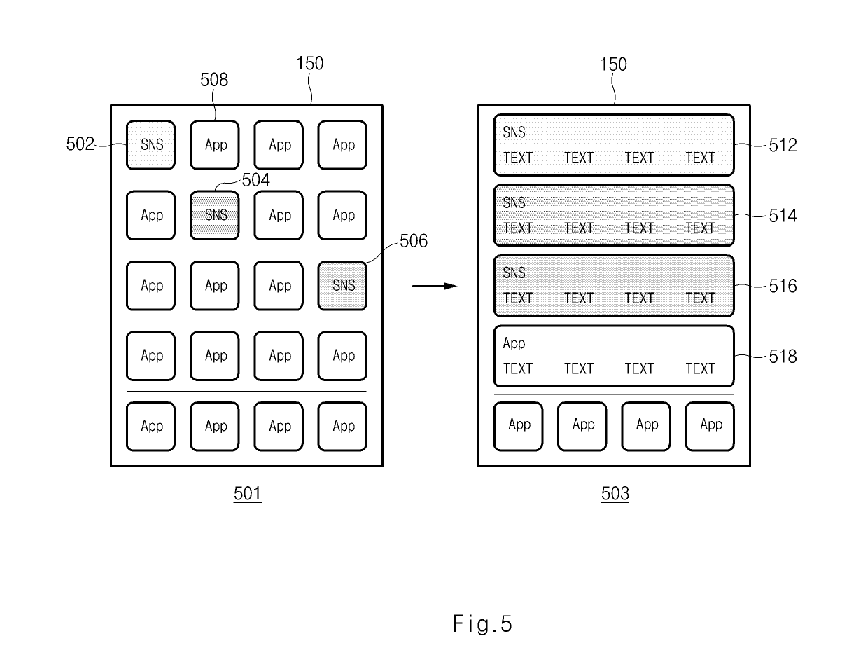

FIG. 5 illustrates an application UI displayed on a screen of an electronic device according to another embodiment of the present invention. Unlike the application UI of FIG. 4, the application UI of FIG. 5 displays, on the screen 150, the execution screen of an application not in a group corresponding to a user input together.

Referring to step 501, the electronic device receives a user input for one of SNS application icons 502 to 506. Referring to step 503, the electronic device displays, on the screen 150, the SNS application screens 512 to 516 based on the user input. The displayed application screen 518 corresponds to an application icon 508 in step 501 not belonging to an SNS group in widget form.

Similar to FIG. 4, the electronic device displays, on the screen 150, an application screen corresponding to reference number not given application icons based on a user input that scrolls the screen 150 vertically or horizontally.

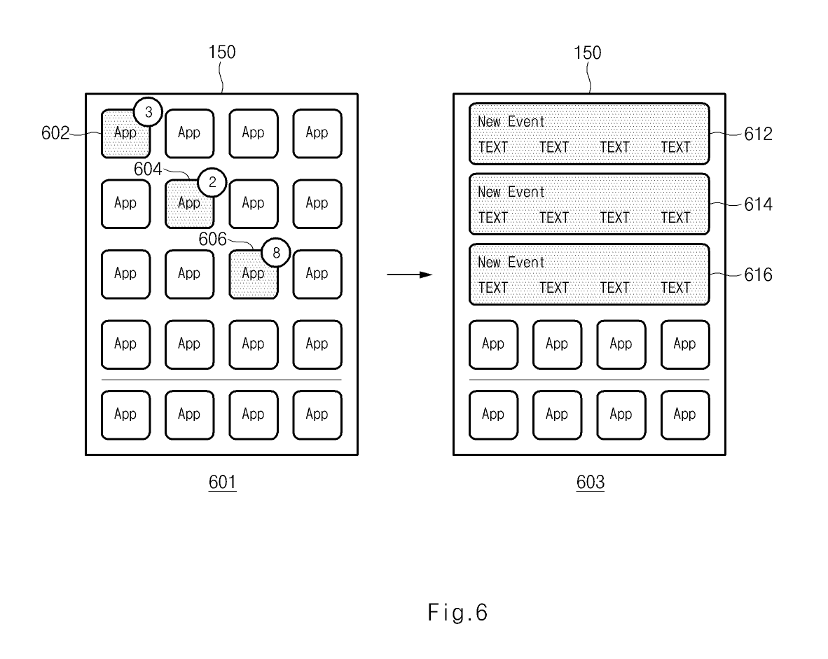

FIG. 6 illustrates an application UI displayed on a screen of an electronic device according to another embodiment of the present invention. The electronic device of FIG. 6 displays an application UI when a plurality of applications with a new message is set as a group.

In step 601, the electronic device displays each of application icons 602, 604, and 606 on the screen 150 and displays numbers 3, 2, and 8 together at the upper right-hand corner of a corresponding application icon. The numbers 3, 2, and 8 represent the number of new messages for a corresponding application. A new message may be an instant message received from another user electronic device of a corresponding application, a notice message received from a business operator of a corresponding application, or a message created by the electronic device 100. For example, the new message may be created when a set notification time is reached.

In step 603, the electronic device displays corresponding application screens 612 to 616 in widget form on the screen 150 based on a user input for a plurality of application icons with a new message.

As mentioned above, the order or size of application screens 612 to 616 may be determined by the execution frequency or user setting of a corresponding application, or based on the number of new messages.

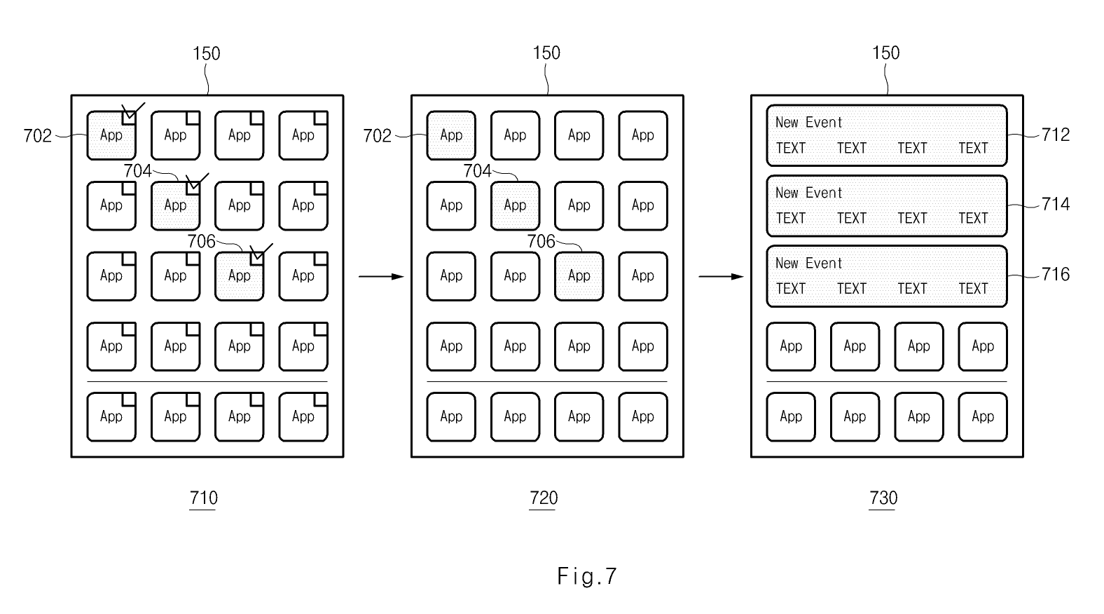

FIG. 7 illustrates an application UI displayed on a screen of an electronic device according to another embodiment of the present invention.

In step 710, the electronic device displays a user setting UI on the screen 150. The electronic device receives a user input one by one for application icons 702, 704, and 706 and an indicator that indicates a selection of one or more of the icons is displayed on the selected application icons 702, 704, and 706, such as by a check mark in a check box.

The electronic device then sets applications corresponding to application icons 702, 704, and 706 as one group based on a user input, such as touching a “check” button or icon, for setting the selected application icons 702, 704, and 706 as a group.

In step 720, the electronic device receives a user input for one of application icons 702, 704, and 706 and in step 730, the electronic device displays application screens 712, 714, and 716 belonging to the same group in widget form on the screen 150 based on the user input.

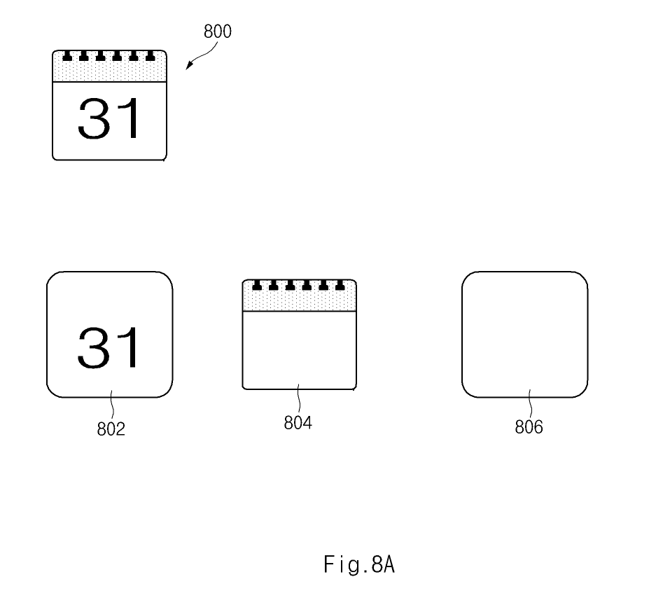

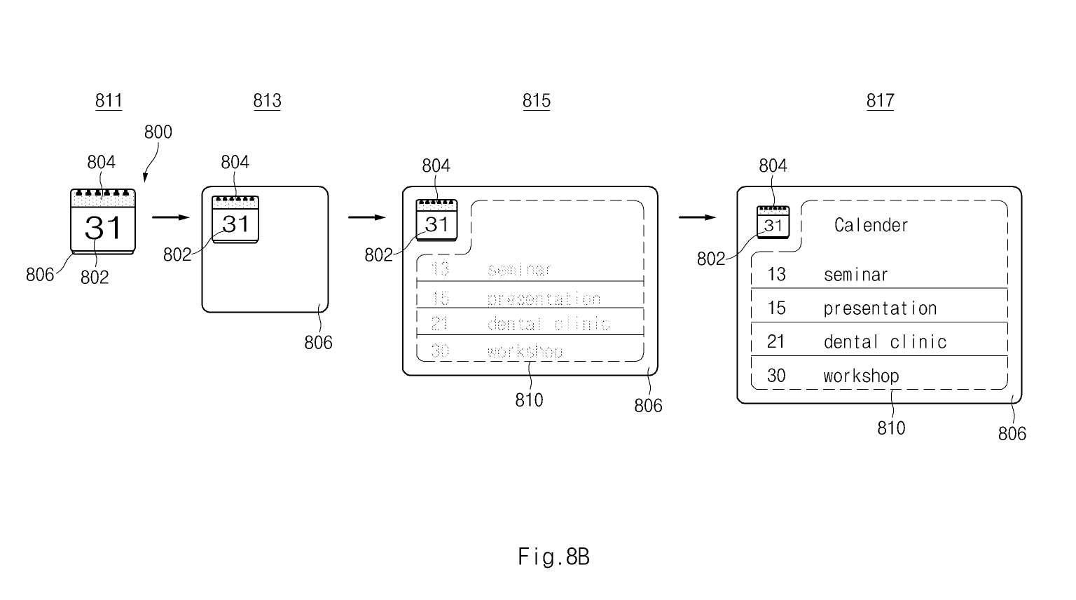

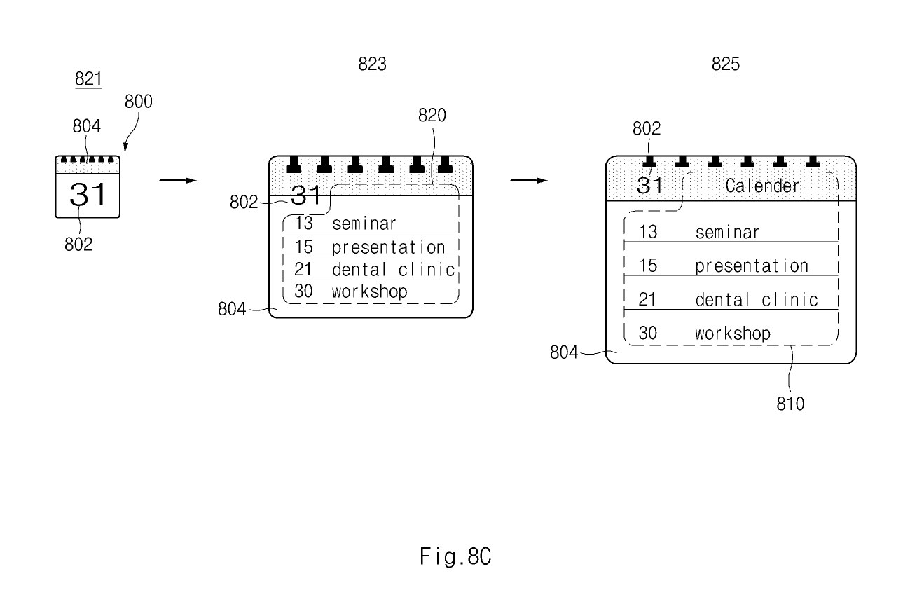

FIGS. 8A to 8C illustrate an application UI for an operation that an electronic device displays an application in widget form according to embodiments of the present invention.

The drawing shown at the top of FIG. 8A illustrates a scheduler application icon 800 as one example of an application icon displayed on the electronic device. The scheduler application icon 800 includes a text layer 802, an image layer 804, and an information layer 806, as shown in FIG. 8A.

The numeral “31” is predetermined text shown in the text layer 802. Additionally, the number shown in the text layer 802 may be the current day. For example, if today is May 15, a numeral “15” may be printed on the text layer 802.

FIG. 8B illustrates the electronic device display of a corresponding application UI based on a user input for the scheduler application icon 800 through steps 811 to 817.

In step 811, the scheduler application icon 800 including the text layer 802, the image layer 804, and the information layer 802 are selected through a user input.

The selected application icon 800 is activated in step 811 to 817. For example, the sizes of the text layer 802 and the image layer 804 may decrease and the size of the information layer 806 may increase.

If the size of the information layer 806 is greater than a predetermined size, schedule information 810 is displayed on the information layer 806. As the size of the information layer 806 increases, the schedule information 810 gradually appears clearer as the font darkens.

Information included in the schedule information 810 may be determined differently according to the size of the information layer 806.

The electronic device displays a corresponding application UI as shown in FIG. 8C based on a user input for the scheduler application icon 800 through steps 821 to 825. The scheduler application icon 800 shown in FIG. 8C may not distinguish the image layer 804 from the information layer 806. For example, the image layer 804 may include information directly without the additional information layer 806, or the image layer 804 and the information layer 806 may be integrated and their sizes may collectively change.

The scheduler application icon 800 including the text layer 802 and the image layer 804 are selected through a user input and the selected application icon 800 are activated through steps 821 to 825.

Unlike an application UI shown in FIG. 8B, in relation to an application UI shown in FIG. 8C, the size of the image layer 804 (or the image layer 804 integrated with the information layer 806) increases and the information 810 on a corresponding application is displayed on the image layer 804.

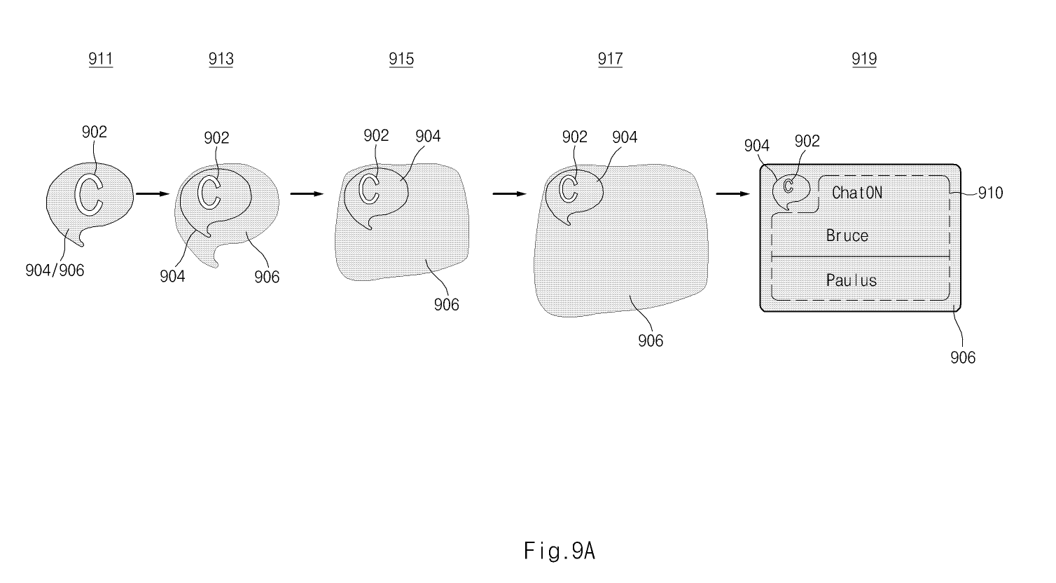

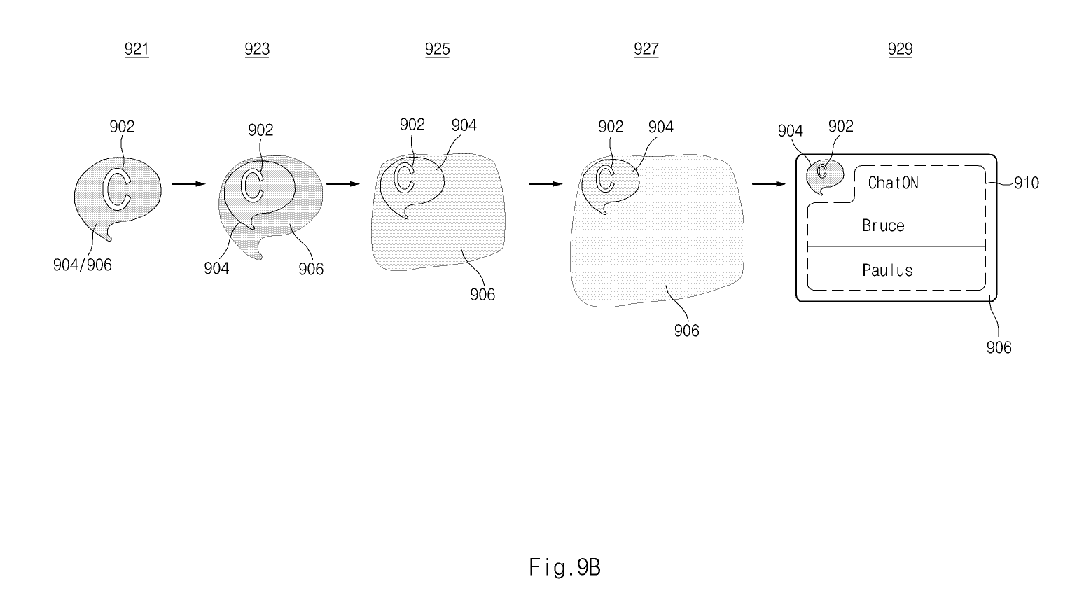

FIGS. 9A and 9B illustrate an application UI for an operation that an electronic device displays an application in widget form according to another embodiment of the present invention. Application icon 900 shown in FIG. 9A and FIG. 9B includes a text layer 902, an image layer 904, and an information layer 906. Unlike application icon 800 shown in FIGS. 8A to 8C, application icon 900 is not in a polygonal form.

Referring to FIG. 9A, an instant message service (IMS) application icon 900 is activated based on a user input in step 911. Based on the activation of the IMS application icon 900, the electronic device displays a corresponding IMS application UI in widget form through steps 913 to 919. The IMS application includes, for example, a text message application or a chatting application.

Since the application UI shown in FIG. 9A is not in a polygonal form, unlike the application UI shown in FIG. 8B, the form of the information layer 906 does not increase while maintaining a predetermined form and may be transformed organically in order to implement a predetermined form, such as the rectangular form in step 919).

The IMS information 910 displayed on the information layer 906 in step 919 includes “Bruce” and “Paulus”, which may be a list of users who most recently receive IMS messages. According to another embodiment of the present invention, “Bruce” and “Paulus” included in the IMS information 910 may be a favorite user list or a highest message transmission/reception frequency list. The IMS information 910 includes IMS message content that is most recently transmitted/received.

Unlike the application UI shown in FIG. 9A, to the color of the information layer 906 of the application UI shown in FIG. 9B gradually changes into a different color than the color of the image layer 904.

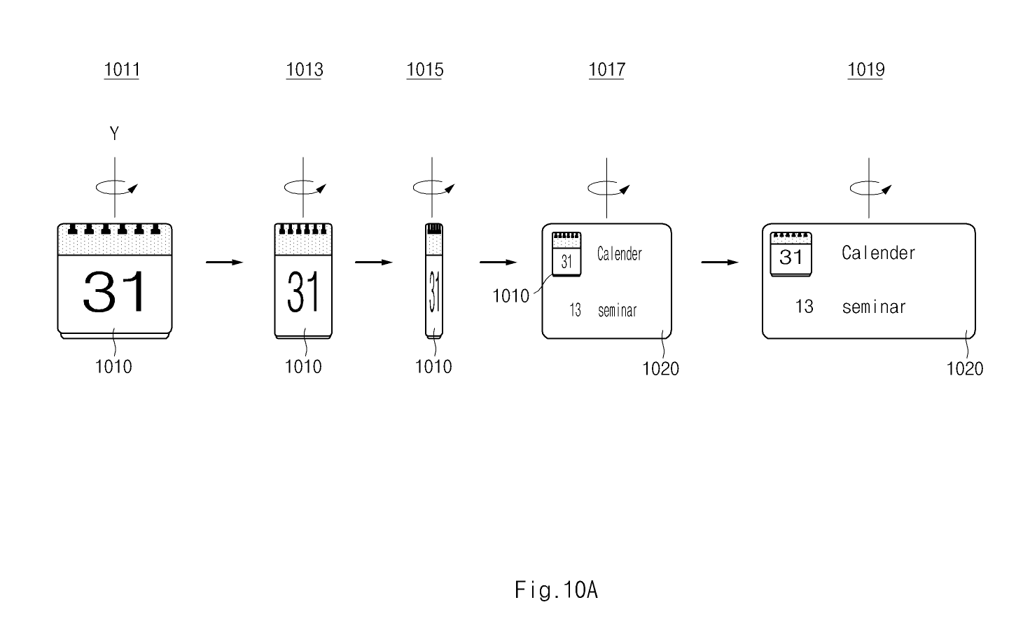

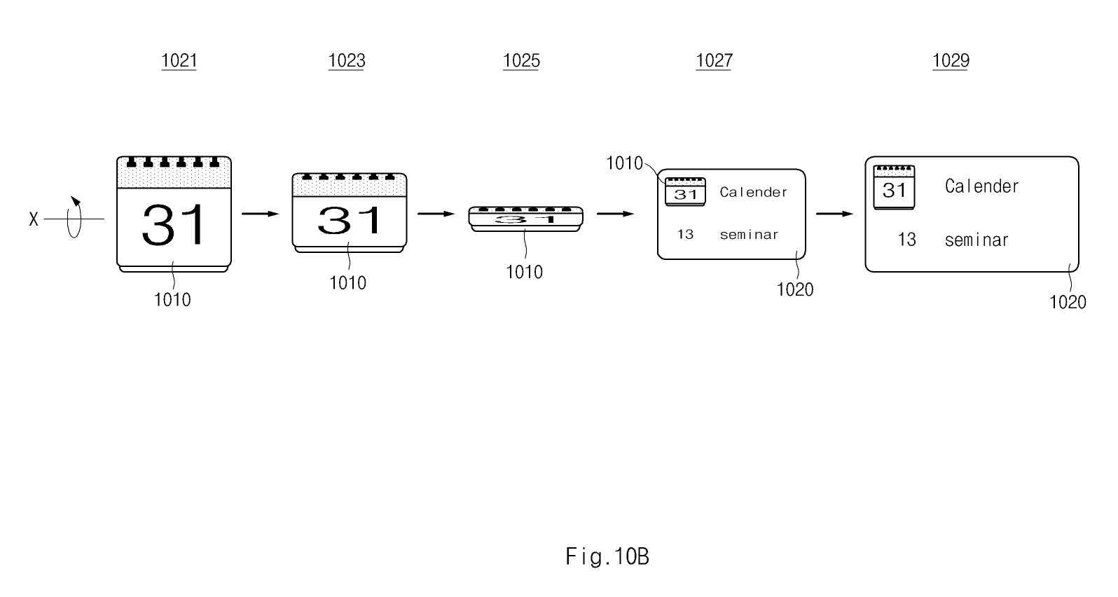

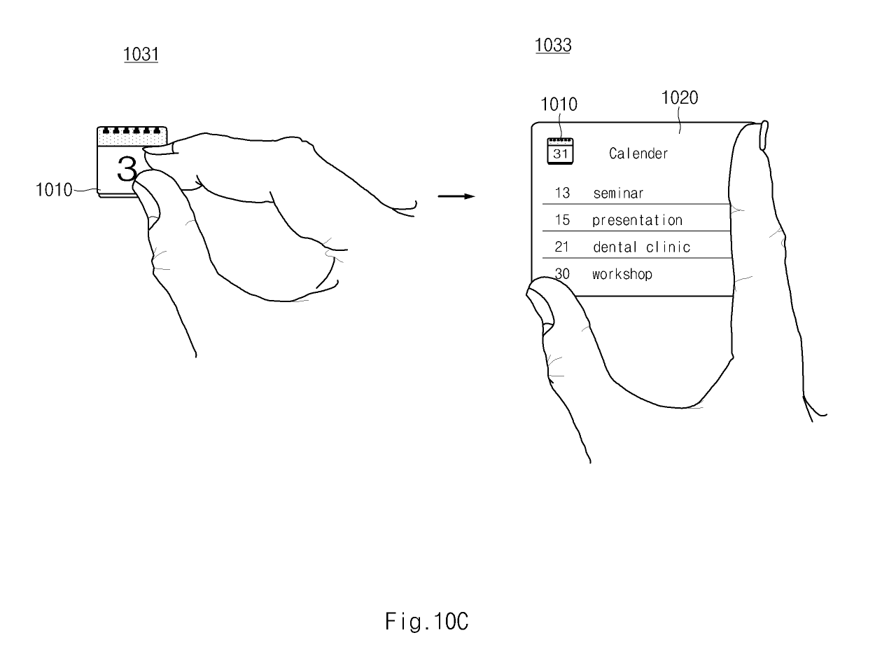

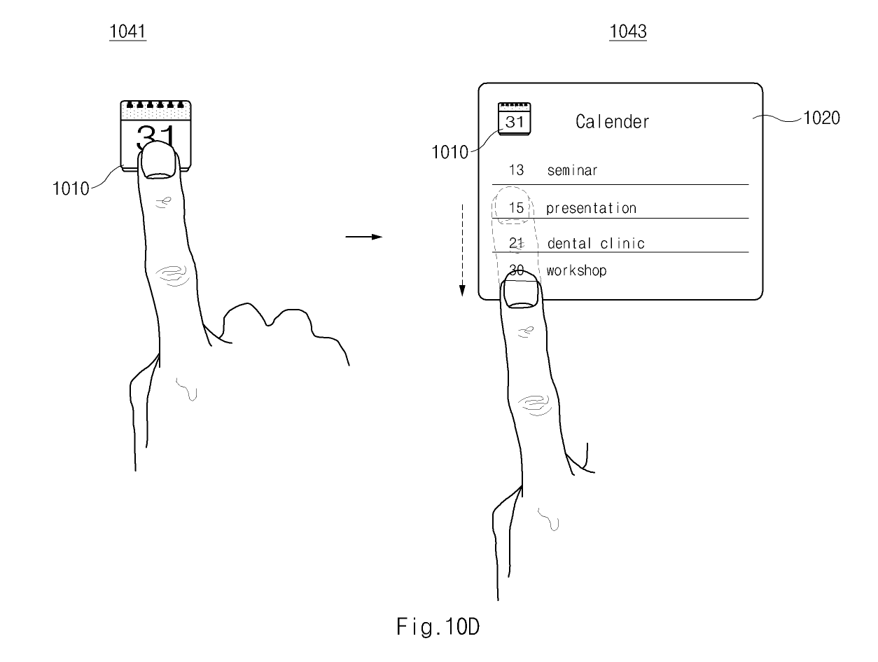

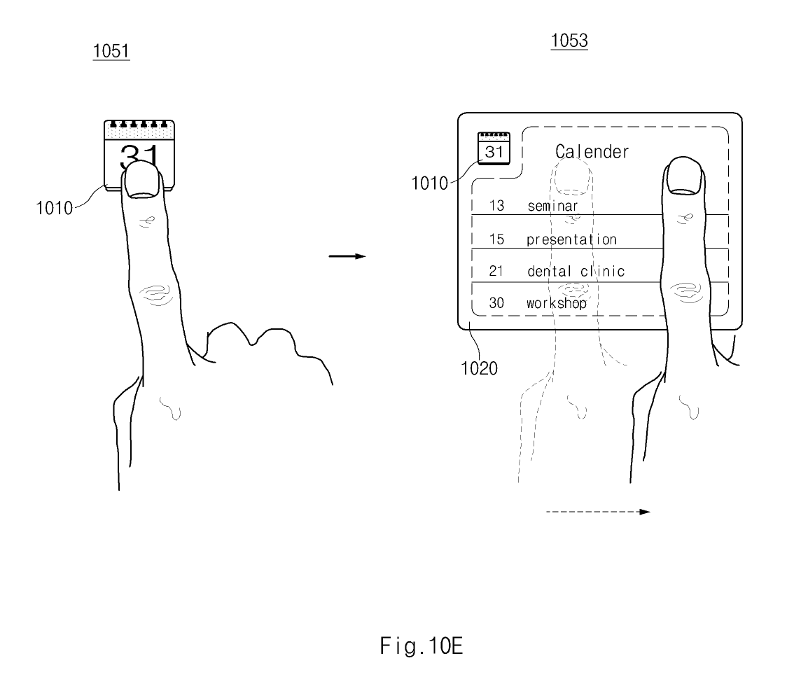

FIGS. 10A to 10E illustrate an application UI for an operation that an electronic device displays an application in widget form according to another embodiment of the present invention.

Referring to FIG. 10A, the electronic device receives a user input for an application icon 1010 in step 1011. The electronic device displays a corresponding application screen in widget form in steps 1011 to 1019.

When receiving a user input, application icon 1010 may rotate about the y-axis of the electronic device, which changes the application icon 1010 into a corresponding application screen 1020 that is displayed in steps 1017-1019.

Referring to FIG. 10B, the electronic device receives a user input for application icon 1010 in step 1021.

Unlike the application UI shown in FIG. 10A, the application UI shown in FIG. 10B displays an application screen 1020 by rotating application icon 1010 based on the x-axis of the electronic device.

Referring to FIG. 10C, the electronic device receives a user input for application icon 1010 in step 1031, such as a pinch-to-zoom operation for spreading application icon 1010 using two fingers while touching.

In step 1033, the electronic device displays a corresponding application screen 1020 in widget form based on the user input, in a size that is determined by the user input, such as a position at which the two fingers are released.

Referring to FIG. 10D, the electronic device receives a user input for application icon 1010 in step 1041, such as a drag operation for dragging in a downward direction by a finger while touching.

In step 1043, the electronic device displays a corresponding application screen 1020 in widget form based on the user input, in a size that is determined based on the user input. For example, the height of application screen 1020 of a corresponding application may be determined based on a position at which the finger is released. The width of application screen 1020 may be determined based on a predetermined size or a predetermined ratio for the determined height.

Similarly to FIG. 10D, referring to step 1053 of FIG. 10E, the electronic device displays application screen 1020 in widget form based on a drag operation for pushing a finger to the right while touching application icon 1010.

The width of application screen 1020 may be determined based on a position at which the finger is released and the height of application screen 1020 may be determined based on a predetermined size or a predetermined ratio for the determined width.

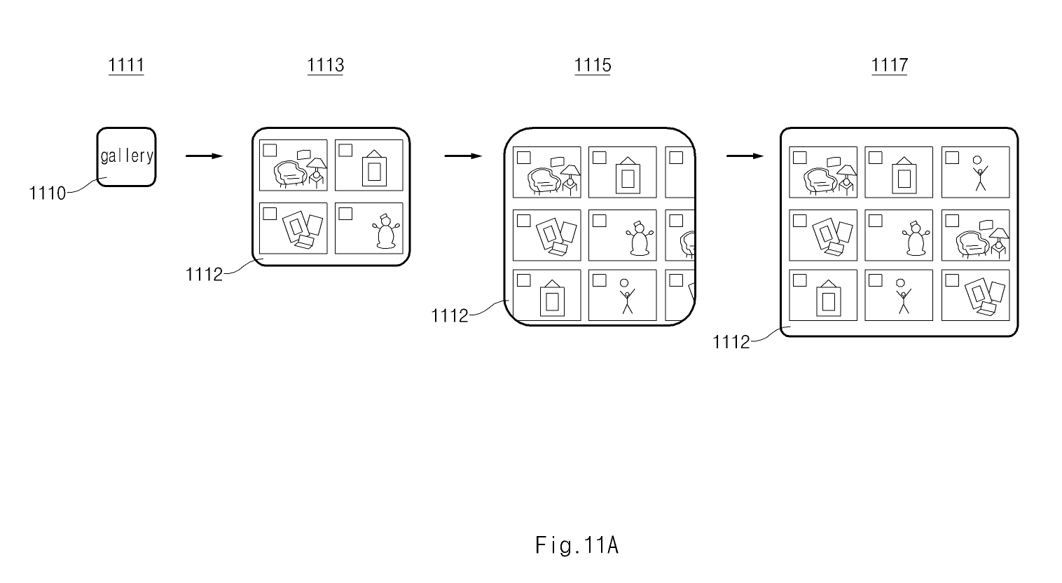

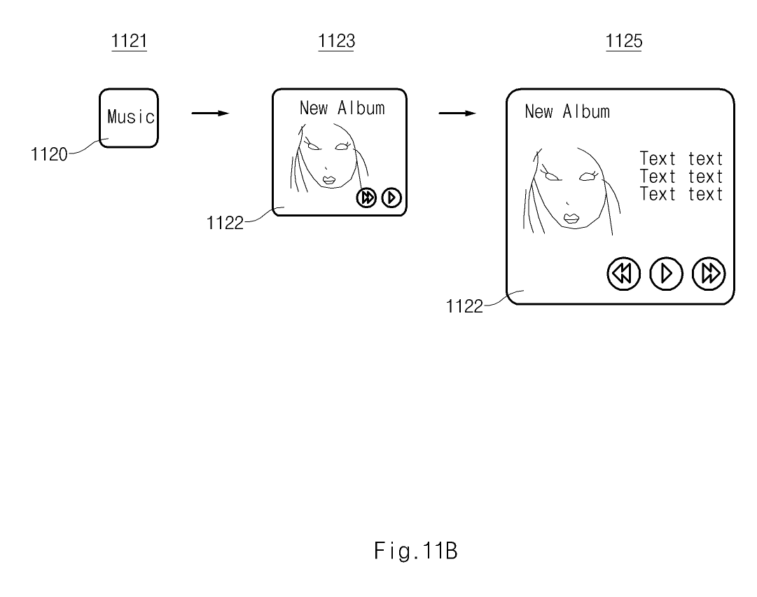

FIGS. 11A to 11B illustrate an application UI depending on a size change of an application screen according to embodiments of the present invention.

Referring to FIG. 11A, the electronic device receives a user input for a gallery application 1110 in step 1111.

The gallery application screen 1112 increases based on the user input and is displayed in widget form on the screen 150 of the electronic device in steps 1113 to 1117.

In steps 1113 to 1117, information displayed on the gallery application screen 1112 varies depending on the size of the gallery application screen 1112.

For example, in step 1113 for displaying a relatively small size of the gallery application screen 1112, a preview image of four sheets included in the gallery application screen 1112 is displayed in an array of 2×2. In step 1115 for displaying a relatively larger gallery application screen 1112, a preview image of nine sheets included in the gallery application screen 1112 is displayed in an array of 3×3. However, some of the nine preview images are only partly displayed due to size constraints of the gallery application screen 1112. In step 1117, the gallery application screen 1112 displays each of the nine preview images.

Referring to FIG. 11B, the electronic device receives a user input for a music application 1120 in step 1121.

The music application screen 1122 increases based on the user input and is displayed in widget form on the screen 150 in steps 1123 to 1125.

In steps 1123 and 1125, information displayed on the music application screen 1122 varies depending on the size of the music application screen 1122.

For example, in step 1123 for displaying a relatively small size of the music application screen 1122, information displayed on the music application screen 1122 includes the album title of a song in playback, a music name, an artist name, and a play/pause trick play icon. The album title, the music name, and the artist name may be scrolled and displayed sequentially without being simultaneously displayed.

In step 1125 for displaying the relatively large music application screen 1122, information displayed on the music application screen 1122 further includes lyrics, a rewind icon, and a fast forward icon, in addition to the displayed information in step 1123. Additionally, an album title, a song name, and an artist name may be displayed simultaneously on the music application screen 1122.

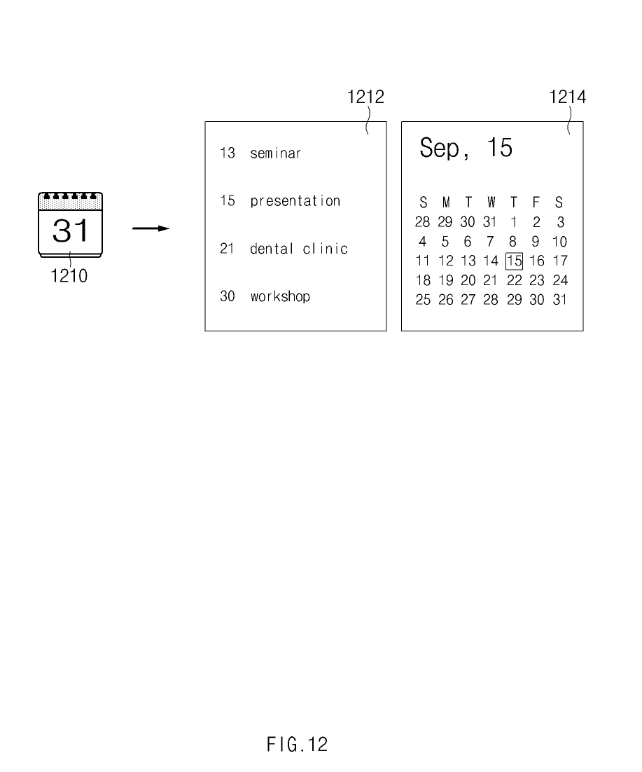

FIG. 12 illustrates an application UI with an application screen including a plurality of areas according to embodiments of the present invention.

The electronic device receives a user input for a schedule application icon 1210. Based on the user input, the electronic device displays a first area 1212 and a second area 1214 as a corresponding schedule application screen.

As shown in FIG. 12, schedule information is displayed in the first area 1212 and a calendar representing the current date and a corresponding month is displayed in the second area 1214.

The first area 1212 and the second area 1214 may be controlled independently based on a user input for each area.

According to embodiments of the present invention, when the electronic device includes a multi screen, the first area 1212 and the second 1214 may be displayed on different screens.

According to embodiments of the present invention, when an electronic device displays a music application screen, album information, artist information, song information, and images are displayed in a first area and song lyrics or a music list are displayed in a second area.

When an electronic device displays an IMS application screen, a list of users who transmit/receive an IMS message is displayed in a first area and a history of IMS messages transmitted/received to/from one user (for example, a user selected from the first area) is displayed in a second area.

An electronic device according to embodiments of the present invention includes a display module for displaying an icon corresponding to each of a plurality of applications on a screen, a user input reception module for receiving a user input for one of the plurality of displayed icons, and a processor for selecting at least one application relating to an application corresponding to the user input. The display module displays an application corresponding to the user input and the related application in widget form on a screen. Each application screen displayed in widget form may be displayed in a partial area of the screen.

A processor according to embodiments of the present invention sets a plurality of applications as a group, and the application corresponding to the user input and the related application is also set as a group.

The processor collects information on the plurality of applications, determines at least two applications as a group by using the collected information, and enables the at least two applications to interoperate and be displayed together in widget form.

The processor 210 determines a plurality of applications corresponding to each category as a group, based on a log-based continuity.

The processor 210 determines the at least two applications as a group based on a log record corresponding to an execution time of the at least two applications, and determines a plurality of applications as a group based on an unchecked new message or a user setting.

The processor 210 determines the size of the application screen displayed in widget form based on a release position of the user input, and determines information included in the application screen displayed in widget form based on the size of the application screen.

The processor 210 determines the size of application screen displayed in widget form based on the execution frequency or user setting of the application, and realigns icons that are not displayed in widget form by each category.

According to embodiments of the present invention, the application screens displayed in widget form may be displayed adjacent to each other, and may include at least two areas that are controlled independently based on a user input for each area.

According to embodiments of the present invention, the application screen displayed in widget form may be displayed at a position corresponding to an icon where the user input is received.

An application UI display method according to embodiments of the present invention includes displaying an icon corresponding to each of a plurality of applications on a screen, receiving a user input for one of the plurality of displayed icons, selecting at least one application relating to an application corresponding to the user input, and displaying an application corresponding to the user input and the related application in widget form on a screen.

According to embodiments of the present invention, the application corresponding to the user input and the related application may be set as one group.

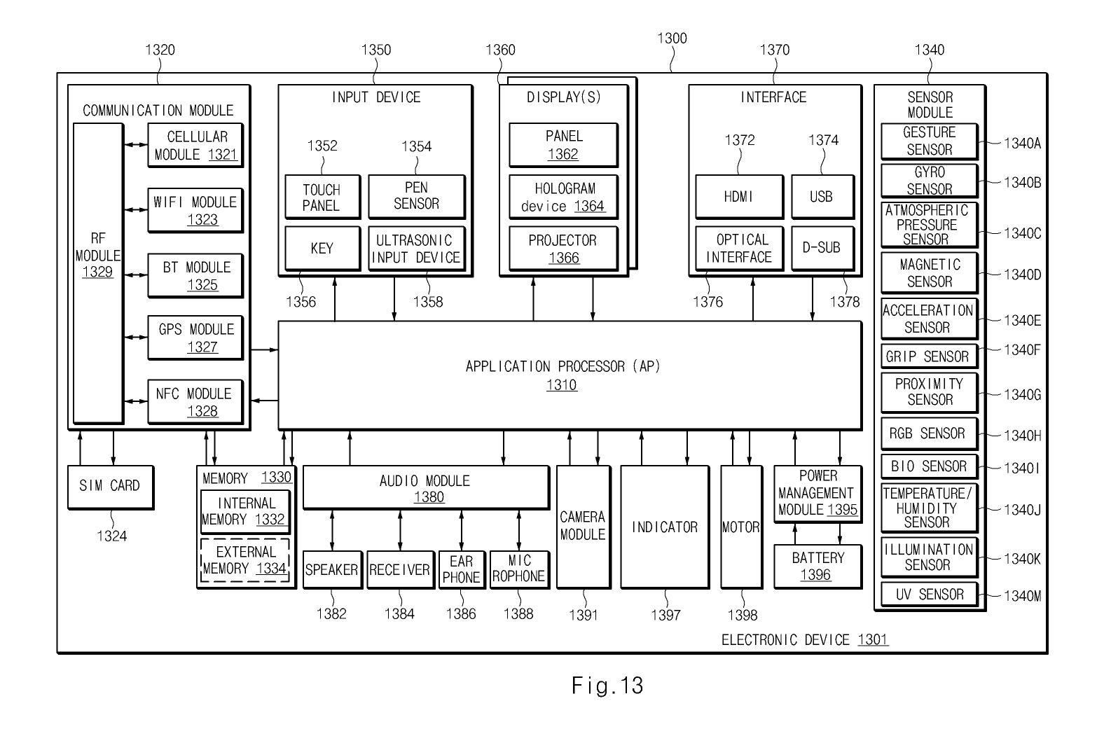

FIG. 13 is a block diagram 1300 illustrating an electronic device 1301 according to embodiments of the present invention. The electronic device 1301 may be configured to include all or part of the electronic device 101 shown in FIG. 1. Referring to FIG. 13, the electronic device 1301 includes application processor (AP) 1310, a communication module 1320, a SIM card 1324, a memory 1330, a sensor module 1340, an input device 1350, at least one display 1360, an interface 1370, an audio module 1380, a camera module 1391, a power management module 1395, a battery 1396, an indicator 1397, and a motor 1398.

The AP 1310 controls a plurality of hardware or software components connected to the AP 1310 and performs various data processing and operations with multimedia data by executing an operating system or an application program. The AP 1310 may be implemented with a system on chip (SoC), for example, and may further include a GPU.

The communication module 1320 performs data transmission/reception through a communication between other electronic devices connected to the electronic device 1301 via a network. According to an embodiment of the present invention, the communication module 1320 includes a cellular module 1321, a WiFi module 1323, a BT module 1325, a GPS module 1327, a near field communication (NFC) module 1328, and a radio frequency (RF) module 1329.

The cellular module 1321 provides voice calls, video calls, text services, or Internet services through a communication network. The cellular module 1321 performs a distinction and authentication operation on an electronic device in a communication network by using the SIM card 1324, for example. According to an embodiment of the present invention, the cellular module 1321 performs at least part of a function provided by the AP 1310, such as a multimedia control function.

According to an embodiment of the present invention, the cellular module 1321 may further include a communication processor (CP), and may be implemented with SoC, for example. As shown in FIG. 13, components such as the cellular module 1321 are separated from the AP 1310, but the AP 1310 may be implemented including some of the aforementioned components, such as the cellular module 1321.

According to an embodiment of the present invention, the AP 1310 or the cellular module 1321 may load instructions or data, which are received from a nonvolatile memory or at least one of other components connected thereto, into a volatile memory and then process the instructions or data. The AP 1310 or the cellular module 1321 stores data received from or generated by at least one of other components in a nonvolatile memory.

Each of the WiFi module 1323, the BT module 1325, the GPS module 1327, and the NFC module 1328 includes a processor for processing data transmitted/received through a corresponding module. Although these modules are shown as separate blocks in FIG. 13, according to an embodiment of the present invention, at least two of these modules may be included in one integrated chip (IC) or an IC package. For example, at least some of processors respectively corresponding to the cellular module 1321, the WiFi module 1323, the BT module 1325, the GPS module 1327, and the NFC module 1328 may be implemented with one SoC.

The RF module 1329 is responsible for data transmission, such as of an RF signal. The RF module 1329 may include a transceiver, a power amp module (PAM), a frequency filter, and a low noise amplifier (LNA). The RF module 1329 may further include components for transmitting/receiving electromagnetic waves on a free space in a wireless communication, such as conductors or conducting wires. Although the cellular module 1321, the WiFi module 1323, the BT module 1325, the GPS module 1327, and the NFC module 1328 share one RF module 1329 shown in FIG. 13, according to an embodiment of the present invention, at least one of these modules may transmit an RF signal through an additional RF module.

The SIM card 1324 may be inserted into a slot formed at a specific position of an electronic device. The SIM card 1324 includes unique identification information such as an integrated circuit card identifier (ICCID) or subscriber information such as an international mobile subscriber identity (IMSI).

The memory 1330 includes an internal memory 1332 and an external memory 1334, and is at least one of a volatile memory such as dynamic RAM (DRAM), static RAM (SRAM), and synchronous dynamic RAM (SDRAM) and a non-volatile memory such as a one-time programmable ROM (OTPROM), programmable ROM (PROM), erasable and programmable ROM (EPROM), electrically erasable and programmable ROM (EEPROM), mask ROM, flash ROM, NAND flash memory, and NOR flash memory.

According to an embodiment of the present invention, the internal memory 1332 may be a solid state drive (SSD). The external memory 1334 may further include flash drive, such as compact flash (CF), secure digital (SD), micro Micro-SD, Mini-SD, extreme digital (xD), or a memory stick. The external memory 1334 may be functionally connected to the electronic device 1301 through various interfaces. According to an embodiment of the present invention, the electronic device 1301 may further include a storage device such as a hard drive.

The sensor module 1340 measures physical quantities or detects an operating state of the electronic device 1301, thereby converting the measured or detected information into electrical signals. The sensor module 1340 includes at least one sensor of a gesture 1340A, gyro 1340B, atmospheric pressure 1340C, magnetic 1340D, acceleration 1340E, grip 1340F, proximity 1340G, a red, green, blue (RGB) 1340H, biometric 13401, temperature/humidity 1340J, illumination 1340K, and ultra violet (UV) 1340M sensors. Additionally or alternatively, the sensor module 1340 may include an E-nose, electromyography (EMG), electroencephalogram (EEG), electrocardiogram (ECG), infra red (IR), iris, or fingerprint sensors. The sensor module 1340 further includes a control circuit for controlling at least one sensor therein.

The input device 1350 includes a touch panel 1352, a (digital) pen sensor 1354, a key 1356, and an ultrasonic input device 1358. The touch panel 1352 recognizes a touch input through at least one of capacitive, resistive, infrared, and ultrasonic methods, for example. The touch panel 1352 may further include a control circuit. In the case of the capacitive method, both direct touch and proximity recognition are possible. The touch panel 1352 may further include a tactile layer, in which case the touch panel 1352 provides a tactile response to a user.

The (digital) pen sensor 1354 may be implemented through a method similar or identical to that of receiving a user's touch input or an additional sheet for recognition. The key 1356 includes a physical button, an optical key, or a keypad, for example. The ultrasonic input device 1358, as a device checking data by detecting sound waves through a microphone (for example, a microphone 1388) in the electronic device 1301, provides wireless recognition through an input tool generating ultrasonic signals. According to an embodiment of the present invention, the electronic device 1301 receives a user input from an external device such as a computer or a server connected to the electronic device 900 through the communication module 1320.

The display 1360 includes a panel 1362, a hologram device 1364, and a projector 1366. The panel 1362 includes a liquid-crystal display (LCD) or an active-matrix organic light-emitting diode (AM-OLED), and is implemented to be flexible, transparent, or wearable, for example. The panel 1362 and the touch panel 1352 may be configured with one module. The hologram 1364 displays three-dimensional images in the air by using the interference of light. The projector 1366 displays an image by projecting light on a screen that is placed inside or outside the electronic device 1301. The display 1360 further includes a control circuit for controlling the panel 1362, the hologram device 1364, and the projector 1366.

The interface 1370 includes a high-definition multimedia interface (HDMI) 1372, a universal serial bus (USB) 1374, an optical interface 1376, and a D-subminiature (sub) 1378. The interface 1370 may be included in the communication interface 160 shown in FIG. 1, and may include a mobile high-definition link (MHL) interface, an SD card/multi-media card (MMC) interface, or an infrared data association (IrDA) standard interface.

The audio module 1380 converts sound into electrical signals and converts electrical signals into sounds. At least some components of the audio module 1380, for example, may be included in the input/output interface 140 shown in FIG. 1. The audio module 1380 processes sound information inputted/outputted through a speaker 1382, a receiver 1384, an earphone 1386, and a microphone 1388.

The camera module 1391, as a device for capturing a still image and a video, includes at least one image sensor such as a front sensor or a rear sensor, a lens, an image signal processor (ISP), and a flash such as a light-emitting diode (LED) or a xenon lamp.

The power management module 1395 manages the power of the electronic device 1301, and may include a power management IC (PMIC), a charger IC, or a battery gauge, for example.

The PMIC may be built in an IC or SoC semiconductor, for example. A charging method may be classified into a wired or wireless method. The charger IC charges a battery and prevents overvoltage or overcurrent flow from a charger. According to an embodiment of the present invention, the charger IC includes a charger IC for at least one of a wired and wireless charging method. The wireless charging method includes a magnetic resonance method, a magnetic induction method, and an electromagnetic method. An additional circuit for wireless charging, such as a circuit such as a coil loop, a resonant circuit, or a rectifier circuit, may be added.

The battery gauge measures the remaining amount of the battery 1396, or a voltage, current, or temperature of the battery 1396 during charging. The battery 1396 stores or generates electricity and supplies power to the electronic device 1301 by using the stored or generated electricity. The battery 1396, for example, includes a rechargeable battery or a solar battery.

The indicator 1397 displays a specific state of the electronic device 1301 or a part such as the AP 1310, booting, message, or charging state. The motor 1398 converts electrical signals into mechanical vibration. The electronic device 1301 may include a processing device for mobile TV support. The processing device processes media data according to the standards such as digital multimedia broadcasting (DMB), digital video broadcasting (DVB), or media flow.

Embodiments of the present invention display a predetermined object or a predetermined screen effect on a screen of an electronic device in response to a user input inputted from a user. In this case, the displayed predetermined object or the predetermined screen effect provides user convenience in an application driven by an electronic device.

Each of the above-mentioned components of the electronic device according to embodiments of the present invention may be configured with at least one component and the name of a corresponding component may vary according to the type of an electronic device. An electronic device according to embodiments of the present invention may or may not include some of the above-mentioned components, or may further include another component. Additionally, some of components in an electronic device according to embodiments of the present invention are configured as one entity, so that functions of previous corresponding components are identically performed.

The term “module” used in embodiments of the present invention, for example, indicates a unit including a combination of at least one of hardware, software, and firmware. The term “module” and the term “unit”, “logic”, “logical block”, “component”, or “circuit” may be interchangeably used, and a “module” may be a minimum unit or part of an integrally configured component, may perform at least one function or part thereof, and may be mechanically or electronically implemented. For example, the “module” may include at least one of an application-specific integrated circuit (ASIC) chip performing certain operations, field-programmable gate arrays (FPGAs), or a programmable-logic device, all of which are known or to be developed in the future.

According to embodiments of the present invention, at least part of a device or a method according to the present invention, as in a form of a programming module, may be implemented using an instruction stored in computer-readable storage media. When at least one processor executes an instruction, it performs a function corresponding to the instruction. The non-transitory computer-readable storage media may include the memory 130. At least part of a programming module may be implemented by the processor 120. At least part of a programming module may include a module, a program, a routine, sets of instructions, or a process to perform at least one function.

The computer-readable storage media may include Magnetic Media such as a hard disk, a floppy disk, and a magnetic tape, optical media such as compact disc read only memory (CD-ROM) and digital versatile disc (DVD), Magneto-Optical Media such as Floptical Disk, and a hardware device especially configured to store and perform a program instruction (for example, a programming module) such as ROM, Random Access Memory (RAM), and flash memory. Additionally, a program instruction may include high-level language code executable by a computer using an interpreter in addition to machine code created by a complier. The hardware device may be configured to operate as at least one software module to perform an operation of embodiments of the present invention and vice versa.

A module or a programming module according to embodiments of the present invention may or may not include some of the above-mentioned components, or may further include another component. Operations performed by a module, a programming module, or other components according to embodiments of the present invention may be executed through a sequential, parallel, repetitive or heuristic method. Additionally, some operations may be executed in a different order or may be omitted. Other operations may be added.

Embodiments of the present invention are provided as certain examples to describe technical content and help understanding and also do not limit the scope of the present invention. Accordingly, it should be construed that besides the embodiments listed herein, all modifications or modified forms derived based on the technical ideas of the present invention are included in the scope of the present invention.

What is claimed is:

1. An electronic device for executing an application, the electronic device comprising:
a display module configured to display, on a screen, a plurality of icons respectively corresponding to a plurality of applications;
a user input reception module configured to receive a user input for one of the plurality of displayed icons; and
a processor configured to select an application corresponding to the user input and a related application to the selected application,
wherein the display module is further configured to display, on the screen, the application corresponding to the user input and the related application in widget form.

2. The electronic device of claim 1, wherein the application corresponding to the user input and the related application displayed in widget form are displayed in a partial area of the screen.

3. The electronic device of claim 1, wherein the processor is further configured to set the application corresponding to the user input and the related application as a group from among the plurality of applications.

4. The electronic device of claim 3, wherein the processor is further configured to:
collect information on the plurality of applications;
set the plurality of applications as the group by using the collected information;
interoperate at least two applications included in the plurality of applications, and
display the interoperated at least two applications together in widget form.

5. The electronic device of claim 4, wherein the plurality of applications is set as the group based on a category of the plurality of applications.

6. The electronic device of claim 5, wherein the category corresponds to at least one of a social network service (SNS) application, multimedia application, game application, scheduler application, instant message application, shopping application, and web application.

7. The electronic device of claim 4, wherein the plurality of applications is set as the group based on a log-based continuity.

8. The electronic device of claim 4, wherein the plurality of applications is set as the group based on a log record corresponding to an execution time of the plurality of applications.

9. The electronic device of claim 4, wherein the plurality of applications is set as the group based on whether there is an unchecked new message included each of the plurality of applications.

10. The electronic device of claim 4, wherein the plurality of applications is set as the group based on a user setting.

11. The electronic device of claim 1, wherein the processor is further configured to determine a size of the application screen displayed in widget form based on a release position of the user input.

12. The electronic device of claim 11, wherein the processor is further configured to determine information to be displayed in the application screen displayed in widget form based on the determined size of the application screen.

13. The electronic device of claim 1, wherein the processor is further configured to determine a size of the application screen displayed in widget form based on one of an execution frequency and user setting of the application.

14. The electronic device of claim 1, wherein the processor is further configured to realign icons that are not displayed in widget form on the screen.

15. The electronic device of claim 14, wherein the realignment of the icons is performed by each category of each application corresponding to the icons.

16. The electronic device of claim 1, wherein the application corresponding to the user input and the related application displayed in widget form are displayed adjacent to each other.

17. The electronic device of claim 1, wherein the application screen displayed in widget form comprises at least two areas that are independently controlled based on a user input at each area.

18. The electronic device of claim 1, wherein the application screen displayed in widget form is displayed at a position corresponding to an icon where the user input is received.

19. A method of displaying an application user interface, the method comprising:
displaying, on a screen, a plurality of icons respectively corresponding to a plurality of applications;
receiving a user input for one of the plurality of displayed icons;
selecting at least one application corresponding to the user input; and
displaying, on the screen, the application corresponding to the user input and a related application in widget form.

20. The method of claim 19, wherein the application corresponding to the user input and the related application are set as one group.
